(19) United States
(12) Patent Application Publication
(10) Pub. No.: US 2009/0252921 A1
(43) Pub. Date: Oct. 8, 2009

(54) METHOD FOR THE PRODUCTION OF A SANDWICH COMPONENT HAVING A HONEYCOMB CORE AND THE SANDWICH COMPONENT OBTAINED IN THIS WAY

(75) Inventors: Oliver Bottler, Konz (DE); Patrick Freres, Echternach (LU)

Correspondence Address: CANTOR COLBURN, LLP, 20 Church Street, 22nd Floor, Hartford, CT, 06103, US

(73) Assignee: EURO-COMPOSITES S.A., Echternach (LU)

(21) Appl. No.: 12/440,336

(22) PCT Filed: Sep. 7, 2007
(86) PCT No.: PCT/EP2007/059431

§ 371 Date: Mar. 6, 2009

(30) Foreign Application Priority Data
Sep. 7, 2006 (EP) 06120325.3

(51) Int. Cl. B32B 3/12; B29D 24/00; B32B 38/08

(52) U.S. Cl. 428/116; 156/286; 156/278

(57) ABSTRACT

The invention relates to a method for the production of a fiber reinforced sandwich component (10) having a honeycomb core (12), the honeycombs of which are closed on both sides. The honeycomb core is closed at least on one side by a cover layer (14) made of fiber material, which is embedded in matrix material. The method comprises the following steps: —Producing a fabric comprising the honeycomb core and at least on one side of the honeycomb core, disposed from the inside to the outside, a curable adhesive layer (20), a barrier layer (16) and a fiber layer (14); —Locking the fabric on a one-sided molding tool (30) in a gastight chamber, which is formed up by a vacuum foil (48) on the one-sided molding tool; —Creating a vacuum in this gastight chamber, —After creating the vacuum, hardening or partial hardening of the adhesive layer between the honeycomb core and barrier layer in this vacuum such that the honeycomb cells (18) are evacuated at least partially before they are closed off by the barrier layer; —After hardening or partially hardening of the adhesive layer, infusion of the fiber layer in a vacuum with a matrix material; and —Hardening of the matrix material in a vacuum.

### TECHNICAL FIELD OF THE INVENTION

The present invention generally relates to lightweight construction fiber composite components in a sandwich construction with an open cell core as supporting material for the fiber composite. In detail, the invention relates to a manufacturing method for such a fiber-reinforced sandwich component with a honeycomb core.

### BRIEF DISCUSSION OF RELATED ART

Fiber-reinforced sandwich components with an open core per se such as for example a honeycomb core, which is closed on both sides by a cover layer in fiber composite, are known per se and find application in the most diverse fields. For example, they are applied in vehicle construction for aviation and space travel, for shipping and also in motor vehicle and railway construction. A very high strength-to-weight ratio belongs to the most important advantages of such components. They therefore contribute to weight reduction. For the cited components, the quality of the bond between the cover layers made in fiber composite and the honeycomb core is i.a. a very important point with regard to high strength.

A known autoclave-based method for manufacturing such components comprises the laying of sandwiched fiber layers impregnated beforehand with uncured resin, so-called “prepregs”, onto the honeycomb core and a subsequent pressure and temperature treatment of the laid material (lay-up) in the autoclave. By means of a treatment in the autoclave cycle, manufacturing of the fiber composite cover layers out of the prepreg layers takes place by gelling and subsequent curing of the resins on the one hand, and binding of the cover layers on the honeycomb core by resin which cures on the honeycomb webs. Such autoclave methods are presently mainly applied for manufacturing high quality fiber composite components with a honeycomb core. In this method, drawbacks are i.a. very high prime and operating costs as well as limitations on the possible component sizes both caused by the autoclave. Furthermore, as a drawback, prepreg technology has costly laying tasks for thin layers, a low shelf life of the prepreg layers and special storage requirements which result from this.

Another known method for manufacturing fiber-reinforced sandwich components with a honeycomb core is based on the so-called RTM (Resin Transfer Molding) method. In this method, the core with layers positioned thereon, of dry, i.e. not pre-impregnated, fiber material is positioned in a closable mold. The mold consists of two heatable mold halves, the inner contour of which corresponds to the outer contour of the finished component. In the closed mold space, liquid resin is fed to the dry fiber material. The resin is cured by heating the mold. Here, the resin may be fed either with excess pressure into the RTM mold or with a vacuum into the RTM mold. The specific pressure difference is used i.a. for avoiding undesirable air inclusions in the cover layer. Various drawbacks of the prepreg technology are avoided by means of dry fiber lay-ups. In such RTM methods, an undesirable penetration of liquid resin into the open cells of the honeycomb core must of course be prevented. Concerning this, it is known how to close the honey comb core on both sides with a barrier layer impervious to resin which prevents filling of the honeycomb cells with liquid resin. The inserted barrier layer is of course a problem insofar that the bond between the honeycomb and the cover layer can no longer be achieved directly through the resin of the cover layer. A corresponding RTM method which applies excess pressure in the mold is known from EP 0 722 825. Corresponding RTM methods, which propose vacuum in the mold are known from EP 0 770 472, EP 0 786 330 and EP 1 281 505. A RTM method, in which resin is injected under overpressure and, in support, a vacuum is produced in the gastight closed mold is known from WO 02/074469. Also, these methods as a matter of fact conceal the drawback of high prime and operating costs. A special expensive heatable RTM mold is required i.a. for each type of component.

On this account, methods which are not based on RTM or autoclave solutions encounter high interest. Such methods should make larger components with a honeycomb core more economical to manufacture in mass production, ideally with equivalent or even better quality.

The so-called VARTM (Vacuum Assisted RTM) methods belong to these methods in which only a single-sided, generally non-heatable moulding tool is used which is sealed with a vacuum bag. In EP 1 524 105, a method was proposed by the applicant, also designated as vacuum infusion method, to be also applied in the manufacturing of sandwich components with an open cell core. Unlike the vacuum bag molding method with prepregs, dry fiber layers and liquid resin infusion are also applied in the VARTM methods.

Presently, VARTM methods as compared with autoclave methods however in part produce lower fiber volume proportions, higher fluctuations in the thickness dimension as well as higher values of porosities of the fiber composite layers. In particular, when they are applied on sandwich components with an open cell core, conditioned i.a. by the barrier layer also required, the quality of the bond between the cover layers made in fiber composite or the barrier layer and the core material also needs to be improved in these methods. For applications requiring very high quality, for example as structural components for aviation, the above difficulties presently prevent wide dissemination of sandwich components, in particular with an open cell core, which were produced economically by means of a VARTM method. DE 10 2005 003 713 in this respect discloses a method for producing fiber-reinforced sandwich components with a hollow body core by means of a vacuum-aided resin infusion method in a single process operation. In particular for the desired production of structural components for aviation technology, this method should guarantee good binding between cover layer(s) and sandwich core. The method according to DE 10 2005 003 713 is characterized in that a resin is used for binding the barrier layer or as an actual barrier layer, the resin's hardening temperature being above the hardening temperature of the resin which used for the cover layer to be made out of a fiber composite.

### BRIEF SUMMARY OF THE INVENTION

The invention proposes a cost-effective method for manufacturing a fiber-reinforced sandwich component with an open cell core, in particular a honeycomb core. With this method, components should be able to be produced, which meet very high quality requirements. In particular, for components manufactured with this method, the bond between the fiber composite cover layers and the core should fulfil higher quality requirements.

The method according to the invention is used for manufacturing a fiber-reinforced sandwich component with a honeycomb core, the webs of which are closed on both sides and this at least on one side by means of a cover layer in fiber material which is embedded in a matrix material. The object of the invention is achieved because the method comprises the following steps:
manufacturing a lay-up comprising the honeycomb core, as well as a curable adhesive layer, a barrier layer and a fiber layer, positioned from the inside to the outside, at least on one side on the honeycomb core;
confining the lay-up on a one-sided moulding tool in a gas-tight space which is formed by means of a vacuum film, which is sealed up on the one-sided moulding tool;
producing a vacuum in this gas-tight space;
after having produced the vacuum, complete or partial curing of the adhesive layer between the honeycomb core and the barrier layer in this vacuum, so that the honeycomb cells are at least partly evacuated before they are closed by the barrier layer;
after complete or partial curing of the adhesive layer, infusing a matrix material into the fiber layer in vacuo; and
completely curing the matrix material in vacuo.

Two essential advantages are obtained i.a. by this method. Owing to the at least partly evacuated honeycomb cells, the adhesive bond between barrier layer(s) and honeycomb core is improved on the one hand, so as to guarantee higher tensile strength in a direction perpendicular to the sandwich layers. It is supposed that this may only be attributed to a more homogenous bond of the adhesive layer(s) on the honeycomb cells and to a minimization of air or gas inclusions in the actual adhesive layer. On the other hand, it is assumed that an undesired formation of pores in the cured matrix material of the cover layer(s) and in the adhesive layer(s) is minimized to the effect that virtually or absolutely no gas diffuses out of the honeycomb cells into the matrix material or the adhesive layer(s) during its curing. A minimization of air or gas inclusions in the matrix material of the cover layer(s) and in the adhesive layer(s) contributes to an improved adhesive bond with the barrier layer or the honeycomb core.

In comparison with RTM methods, only a one-sided moulding tool is required, which must not be heatable. By means of the vacuum in the closed space, the outer, usually atmospheric pressure on the vacuum film is used for forming the upper surface of the component lying on the moulding tool.

Contrary to the unanimous opinion hitherto, that fiber-reinforced sandwich components, which should meet high quality requirements, e.g. for application as structural components in aviation, may only be manufactured by means of autoclave- or possibly RTM-based methods, it turns out that high quality components may be manufactured with the proposed modified methods without autoclave and without overpressure. As compared with traditional autoclave- or RTM-based methods, which were used up to now for manufacturing sandwich components with high strength and low porosity, components of high quality may therefore be manufactured with the method according to the invention essentially in a more economical way.

In a particularly preferred embodiment, before confining the lay-up in the gas-tight space, the method further comprises confinement of the lay-up in a partial space impervious with respect to the matrix material inside the gas-tight space by means of a microporous membrane, which is impervious regarding a matrix material and pervious for gases. With the help of this membrane, a vacuum is also applied to the partial space, without the possibility of any liquid matrix material flowing out of this partial space. For this modification, the principle of the so-called VAP method (Vacuum Assisted Process) is applied, which represents an improved VARTM method. The VAP method is described in more detail for example in patents DE 198 13 104 and EP 1 181 149 and in an article entitled “VAP für Faserverbundteile” (VAP for fiber composite parts) from the journal “Automotive Materials”, issue 03/05, pages 38-40. By using a membrane, the pore size of which is selected so that air and other gases may be discharged without hindrance, the resin however not being able to penetrate through the membrane, de-aeration or degassing of the matrix material is achieved during infusion and curing, and consequently an even smaller porosity of the fiber composite material is obtained. The membrane develops its effect by allowing uniform de-aeration or degassing, over the whole surface impregnated with matrix material in the transverse direction. In this way, it is possible to obtain improved flow behavior of the liquid infused resin and avoid so-called “dry spots”.

In combination with the method according to the invention, it has additionally been emphasized, that the targeted uniform and large-surface de-aeration or degassing by the VAP method has a positive effect in two respects on the improvement of the adhesive bond between the fiber composite cover layers and the honeycomb pore. On the one hand, both the honeycomb cells and the curing adhesive layer(s) are more regularly, more rapidly degassed or de-aerated to a larger extent, the bond between barrier layer(s) and honeycomb core being thereby further improved. On the other hand, pore formation in the matrix material of the fiber composite is drastically reduced, by which the adhesive bond between cover layer(s) and barrier layer(s) i.a. meets higher requirements. Lower porosity of the cover layer(s) also means lower susceptibility of the sandwich component to undesired moisture accumulation in the honeycomb cells. Long term moisture accumulation increasing weight may occur for example by condensate formation under temperature and pressure fluctuations, in particular in an application such as a structural component in aviation. Concerning this, is should be noted that by an appropriate selection of the barrier layer(s) and the adhesive layer(s), the latter also produce a substantial contribution to reducing moisture accumulation in the honeycomb cells.

In an alternative method, vacuum infusion is applied according to the so-called “resin infusion” principle, for impregnating the fiber layer with matrix material. Here, the infusion of the fiber layer(s) comprises an impregnation of the fiber material by means of liquid matrix material, which is fed to the lay-up from the outside.

In an alternative or additional alternative method, vacuum infusion is applied according to the so-called “resin film infusion” principle, for impregnating the fiber layer with matrix material. Here, the infusion of the fiber layer(s) comprises impregnation of the fiber material with the aid of a liquefied matrix material consisting of one or more matrix material films initially belonging to the lay-up.

As a barrier layer, a sheet is preferably used which is surface-treated, preferably by a plasma or corona surface treatment, by means of a coating method or by a combination of the latter. A coating method enables a chemically/physically improved coupling layer for the adhesive layer(s) and/or the matrix material. The surface condition may specifically be influenced by a plasma or corona surface treatment. By both of these steps, either alone or combined, the current adhesive bond may be further improved.

Preferably, in the method, the dwelling time of the lay-up in vacuo and/or the gradient of the temperature curve are selected before partial or complete curing of the adhesive layer under the effect of temperature so as to achieve maximum evacuation of the honeycomb cells, before the adhesive layer is partly or completely cured. Maximum evacuation corresponds at least approximately to the produced vacuum. Further, a vacuum of ≦10 mbar, preferably ≦1 mbar, is preferably produced, in order to achieve de-aeration or degassing as large as possible, both for the honeycomb cells and the matrix material. The differential pressure produced by the vacuum may of course also be further reduced depending on the matrix material and/or adhesive layer material used during curing, in order to prevent the current material from reaching its boiling point. Preferably the method is performed so that a partial vacuum ≦100 mbars, preferably ≦50 mbars, is produced on average in the honeycomb cells, before the process temperature for complete or partial curing of the adhesive layer is reached. Indeed, with suitable measures, a vacuum of ≦10 mbars may be produced on average in the honeycomb cells, before the process temperature for complete or partial curing of the adhesive layer is reached. Further, it turned out that no special de-aeration layers are necessary for sufficiently evacuating the honeycomb cells, i.e. the curable adhesive layer may be positioned immediately on the honeycomb core and the barrier layer immediately on the adhesive layer.

Complete or partial curing of the adhesive layer by the effect of heat may be performed at a first process temperature, which is lower than a second process temperature which is set for completely curing the matrix material. In this case, it is advantageous to use an adhesive layer, preferably an adhesive film based on an epoxy resin or a phenolic resin or a mixture thereof, which may be cured in the range of the first and of the second process temperature or at least may be partially cured in the range of the first process temperature and completely cured in the range of the second process temperature. In this way, unintended and uncontrolled modifications (for example, modification of the Young modulus, crack formation, etc.) of the adhesive layer(s) by excess temperature equalization during curing of the matrix material are avoided on the one hand. On the other hand, savings may be made by definitively curing the so-called “dually curable” adhesive layer, only during the curing phase of the matrix material. Here, the adhesive layer and matrix material are selected so that the infusion temperature of the matrix material essentially corresponds to the process temperature for complete or partial curing of the adhesive layer.

In order to further optimize binding of the barrier layer(s) onto the honeycomb core, the method preferably comprises initial pre-drying, blowing-out, and/or surface cleaning of the honeycomb core. Additionally, the adhesive films used for the adhesive layer may be pressed against the honeycomb core, before the barrier layer is applied thereon.

The sandwich components which may be manufactured according to the methods described above are characterized in that the cover layer has a pore volume content ≦2%. Furthermore these sandwich components are characterized in that with the sandwich component, a tensile strength perpendicular to the sandwich layers (flatwise tensile strength) of ≧3 MPa, (=N/mm²), preferably ≧4 MPa corresponding to AITM 1.0025 (Issue 1) is achieved, or rather, for a corresponding intrinsic tensile strength of the honeycomb core of <3 MPa or <4 MPa, a honeycomb failure is achieved in a tensile test. Here, it should in particular be noteworthy that right up to the cited tensile strength, no failure occurs in the corresponding adhesive bonds between the cover layer and the barrier layer or between the barrier and the honeycomb core. The tensile strength value is a measure of the general strength of the sandwich component.

With the method according to the invention, according to the materials and alternative methods used, even higher tensile strength values or even lower porosity values may also be achieved. It should be taken into account that sandwich components with a honeycomb core, which only approximately fulfill this requirement of quality, were only able to be manufactured up to now generally by means of more expensive autoclave-assisted methods.

Preferably, the sandwich component has a tensile strength perpendicularly to the sandwich layers of at least 1.5 MPa, corresponding to AITM 1.0025 (Issue 1), i.e. no honeycomb failure occurs right up to this value.

If additionally the membrane according to the VAP principle is used in the method, sandwich components, especially such of large surface, may be manufactured with a honeycomb core, the cover layer of which has a pore volume content <0.5%. The pore volume content may be detected or monitored by non-destructive testing, for example based on known ultrasound or X-ray methods.

Finally, there remains to be observed that, although the method according to the invention is mainly considered for manufacturing sandwich components with a honeycomb core, the method may also advantageously be applied with other open cell core material types, such as for example open cell foams which are difficult to compact, preferably of lower density, for example metal foams.

### BRIEF DESCRIPTION OF THE FIGURES

Further details and advantages of the invention may be gathered from the following detailed description of possible embodiments of the invention with the aid of the appended figures.

FIG. 1 shows a schematic cross-section of a fiber-reinforced sandwich component with a honeycomb core, which was manufactured by means of the method according to the invention;

FIG. 2 shows a schematic laid fabric (lay-up) for preparing a honeycomb core for the method according to the invention;

FIG. 3 shows a schematic structure, with a laid fabric (lay-up) comprising the honeycomb core prepared beforehand, for an embodiment of the method according to the invention;

FIG. 4 shows a schematic structure for a further embodiment of the method according to the invention;

FIG. 5 shows a time course diagram for a first example of further steps of the method;

FIG. 6 shows a time course diagram for a second example of further steps of the method;

FIG. 7 shows a time course diagram for a third example of further steps of the method.

### DETAILED DESCRIPTION OF THE INVENTION

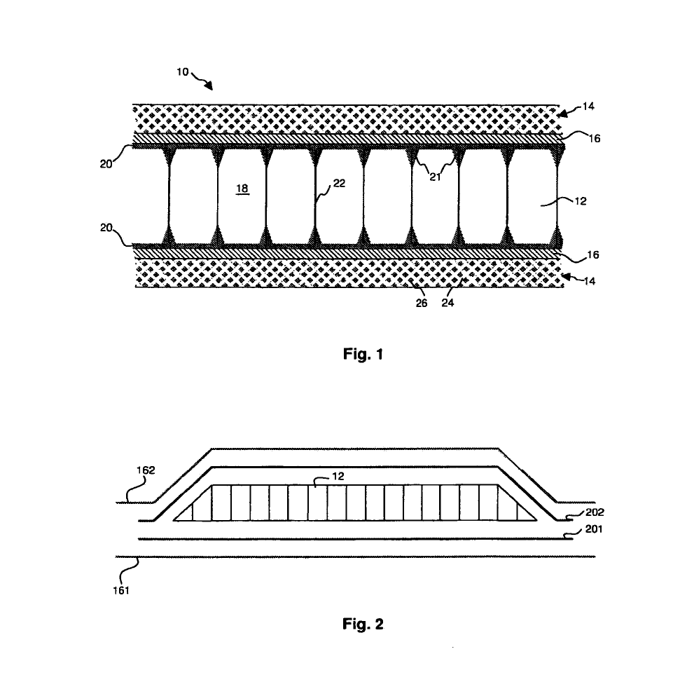

A fiber-reinforced sandwich component manufactured in lightweight construction is schematically illustrated in FIG. 1 and not to scale and generally designated by reference mark 10. The sandwich component 10 comprises an originally open cell honeycomb core 12. Furthermore the sandwich component 10 comprises two cover layers 14 made in fiber composite, which close the honeycomb core 12 on both sides and reinforce the latter. In each case, a separation or barrier layer 16 is positioned between the cover layers 14 and the honeycomb core 12. By means of the barrier layer 16, unintended penetration of uncured matrix material into the empty cells 18 open in the direction of the cover layer of the honeycomb core 12 is prevented during manufacturing of the sandwich component 10. FIG. 1 further shows cured adhesive layers 20 on both sides, between the barrier layer 16 and the honeycomb core 12. The cured adhesive layers 20 form an adhesive bond between the barrier layer 16 and the honeycomb core 12. As shown in FIG. 1, the adhesive layers comprise wedge-shaped extensions 21 which additionally bind and fix the barrier layer 16, similar to angled struts, onto the webs 22 of the honeycomb core 12. Both the adhesive layer 20 per se, and its extensions 21 are relatively homogenously distributed in the finished sandwich component, whereby a homogenous bond between the barrier layer 16 and the honeycomb core 12 is obtained. The cover layers 14 are however each bound directly to the barrier layer 16 and via the latter to the honeycomb core 12 by means of their cured matrix material.

In the embodiment shown, the honeycomb core 12 itself comprises aramide fibers impregnated with phenolic resin (for example Nomex® or Kevlar® available from Du Pont de Nemours (Germany) GmbH), which, with methods known per se, are cut out and transformed into a flat regular honeycomb structure with hexagonal sections. Other materials and moulds for the honeycomb core 12 are not excluded. The barrier layer 16 comprises a sheet made in a thermoplastic, preferably polyvinyl chloride, and is surface-treated on both sides, in order to improve its binding properties to the adhesive layer 20 and to the matrix material of the cover layer 14. The barrier layer 16 used in each case is impervious for the matrix material of the cover layer 14 and temperature-resistant at temperatures which are above the curing temperature of the matrix material (for example temperature-resistant up to 200° C.). A plasma or corona surface treatment is considered as a preferred surface treatment for the sheet of the barrier layer 16 in order to increase the surface roughness in the microstructure area. Alternatively, or additionally to this, the sheet of the barrier layer 16 may be surface-treated by means of a coating method, for example by primers in order to improve the chemical or chemo-physical bonding properties. Furthermore, preferably, the barrier layer 16 is not or only minimally pervious to gases, the sandwich component 10 being thereby further protected against penetration of moisture. An adhesive film is used as an adhesive layer 20, which is initially positioned between the honeycomb core 12 and the barrier layer 16. When using a resin for the adhesive layer 20, the latter is preferably dually curable (see further below).

In the embodiment shown in FIG. 1, the fiber composite cover layer 14 is manufactured out of a tissue or lay-up 24 in carbon or glass fibers (CFK, GFK), which are embedded in cured matrix material 26. For example, In the embodiment of FIG. 1, a one-component epoxy resin system was used as a matrix material (for example HexFlow® RTM 6 available from Hexcel Corp. USA). Other fiber or non-woven materials and other matrix materials are however not excluded.

Components manufactured according to the invention however are not only suitable as structural components for aviation. On the one hand, the sandwich component 10 is distinguished by low porosity of the fiber composite cover layers 14, i.e. by a pore volume content less than 2.0%, when using a typical epoxy resin system in one of the methods described further below. When applying the VAP principle (see below), which is particularly preferred for large-surface components, the pore volume content is usually even substantially less than 0.5%. The pore content may be examined non-destructively by means of known X-ray or ultrasound methods. On the other hand, the sandwich component 10 is distinguished by very good adhesion between the fiber composite cover layer 14 and the honeycomb core 12 (specialized term: flatwise tensile strength”), which for example is expressed in that in tensile loading tests for determined product types, no failure was detected in the cover layer-barrier layer (14-16) or barrier layer-honeycomb core (16-12) interfaces, but at most a failure of the honeycomb core 12 alone was obtained. This is significant to the extent that in the case of insufficient tensile strength of the honeycomb core 12, a more tensile resistant honeycomb type may easily be used; it is however more difficult to improve the adhesive bonds. The sandwich component 10 because of the improved adhesion between the respective cover layer 14 and the honeycomb core 12 achieves a very high strength-to-weight ratio.

With test models, which were manufactured with the method according to the invention, tensile loading tests were carried out as traction-adhesive strength tests according to the “Airbus Industrie Test Method; Fiber Reinforced Plastics; Flatwise tensile test of composite sandwich panel” specification: AITM 1.0025, Issue 1, October 1994. As test models, specimens made out of a sandwich component were used with the following characteristics:
honeycomb core: honeycomb type: Kevlar honeycomb ECK with cell size: 3.2 and specific gravity: 40 kg m³;
barrier layer: surface treated polyvinyl chloride (PVF) sheet:
adhesive layer: epoxy resin adhesive film Hysol EA 9695 0.50 PSF K (manufacturer: Henkel Loctite), 2 layers per side;
cover layer: tissue type: carbon tissue Twill 2/2, 370 g/m² (for example, G926 Injektex tissue), 6 layers per side and Hexcel RTM 6 resin type.

In these tensile loading tests, the following tensile strength values in a direction transverse to the layers (“flatwise”) were reported for six specimens: 4.45; 4.57; 3.87; 4.60; 3.82 and 4.26 MPa. From this, an average value is obtained for the tensile strength transversely to the layers (“flatwise tensile strength) of 4.26 MPa.

In the following with the help of FIGS. 2-7, preferred embodiments of methods for manufacturing sandwich components with the properties discussed above, are described in detail.

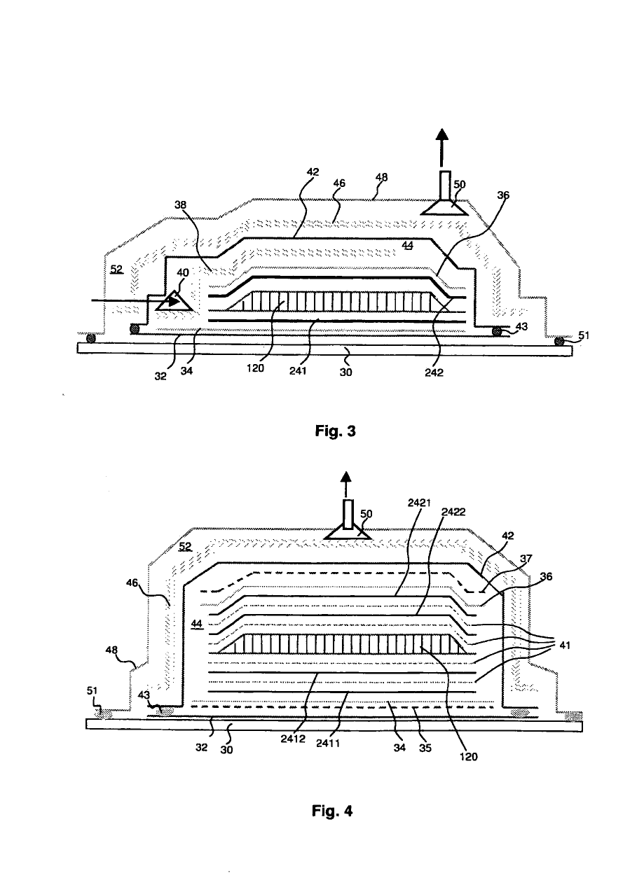

FIG. 2 schematically shows a structure for preparing a honeycomb core 12 for a method according to FIG. 3 or FIG. 4. The honeycomb core 12 shown in FIG. 2 is first pre-treated with regard to the subsequent adhesive bond with the barrier layer 16. For this, the honeycomb core 12 is pre-dried for about 2-3 hrs at 120° C. in a dry oven, subsequently blown, for example with nitrogen, on both sides for cleaning, and is then surface-cleaned with a detergent, for example acetone. For the preparation according to FIG. 2, the first adhesive film 201 for example made in epoxy resin with a surface weight of 50-500 g/m² is cut and laid out. Solely slight tackiness is imparted to the adhesive film 201 by slightly warming the surface for example by means of a supply of hot air. The honeycomb core 12 is positioned on the adhesive film 201 and pressed against the adhesive film. A second adhesive film 202 is cut and applied in the same way with slight tackiness on the upper side of the honeycomb core 12. In order to support the subsequent bond to the honeycomb core 12, as well as to form the contour on the honeycomb core 12, the honeycomb core 12 provided with the adhesive films 201, 202, may optionally be preformed under a vacuum bag or a vacuum membrane press so as to conform with the contour on the honeycomb surface. In certain cases, for each adhesive layer 20, a combination of two or more adhesive films in particular of a different type, is used at each time. In this way, not only the surface-related adhesive mass, but also generally the properties of the adhesive layer 20 may be specifically influenced.

According to FIG. 2, an upper and a lower sheet 161, 162 are next cut suitably for the barrier layers 16, are directly applied on the outer sides of the adhesive films 201, 202 and held in position on the honeycomb core 12. Optionally, slight tackiness may be gradually imparted to the adhesive films 201, 202. In order to prevent subsequent undesired leaking of the adhesive layer 20 into the cover layers 14 (not shown in FIG. 2), the adhesive films 201, 202 are cut out so as to be smaller than the sheets 161, 162. The overhang of the sheets 161, 162 is selected so that the gelled adhesive flows out of the adhesive films 201, 202 during the subsequent curing process at most right up to the edge of the sheets 161, 162, however not in the cover layers 14. As an alternative to this, the sheets 161, 162 might also be peripherally closed by welding for example. If necessary, the sheets 161, 162 and possibly the adhesive films 201, 202, are repeatedly cut out subsequently. The honeycomb core 12 prepared beforehand is made ready by the steps described above. Although a honeycomb core 12 is formed with a simple surface geometry, basically any surface profiles and core shapes may be used. In addition to the sandwich component 10 illustrated in FIG. 1 with fiber composites on both sides, sandwich components may also be manufactured, which are closed only on one side with a cover layer made in fiber composite and on the opposite side with another material.

For the method described further below, it is important that the honeycomb core 12 not be closed gas-tightly, at least until partial or complete curing of the adhesive layers 20. In the alternative shown in FIG. 2, the honeycomb core 12 after its preparation is i.a not closed gas-tightly, so that in the boundary area between the adhesive films 201, 202 or between the sheets 161, 162, gas may escape sideways. Certain components may require that the honeycomb core 12 per se be provided with a border of filling mass in the honeycomb cells 22 of the boundary area (so-called “potting”), for example with the purpose of fixing the finished sandwich component 10 onto another structure. For peripherally closed sheets 161, 162, or a gas-tight border, steps described further below are recommended in order to prevent the honeycomb core 12 from being hermetically sealed, in particular when minimally gas-pervious or gas-impervious sheets 161, 162 are used. Alternatively or additionally to this, sheets 161, 162 with a certain perviousness to gases, for example microporous sheets 161, 162, may also be used, which however are also impervious for the matrix material 26 of the cover layers 14. In other words, means or steps are provided which, at least before the subsequent partial or complete curing of the adhesive films 201, 202, allow a relatively fast and complete evacuation of air or of gas from the honeycomb cells 18 of the prepared honeycomb core 12, without using to this effect, an additional layer for de-aeration purposes between the respective barrier layer sheets (161, 162) and the honeycomb core.

FIG. 3 schematically shows an exemplary structure for performing a first alternative method (specialized term: “resin infusion”: RI). In FIG. 3, for sake of clarity, the honeycomb core, which was prepared according to FIG. 2 with the adhesive films 201, 202 directly on the honeycomb core and the barrier layer sheets 161, 162, each directly on the adhesive films 201, 202, is designated by the reference mark 120. FIG. 3 shows a one-sided moulding tool 30 in a solid gas-tight material, the upper side of which corresponds to the underside of the finished sandwich component 10. The moulding tool 30 is initially treated with a release agent. A first lower microporous membrane 32 is laid on the mould, according to the VAP principle (for example available under reference 4144020 from W.L. Gore & associates GmbH/Germany or under “VAP membrane” from SAERTEX GmbH & Co. KG/Germany). This VAP membrane 32 is pervious to gases, but impervious for liquid matrix material (resin system, see 26 in FIG. 1). A lower layer of peelable tissue 34 (specialized term: peel ply) of a suitable type, is laid down on the membrane 32. The cut-out lower tissue or lay-up layers 241 of dry fiber material (for example carbon or glass fibers) required for the lower cover layer 14 are laid down on the peel ply 34. Subsequently the prepared honeycomb core 120 is positioned on the tissue or lay-up layers 241. The laying of the upper tissue or lay-up layers 242 for the upper cover layer 14 as well as of an upper layer of peel ply 36, correspondingly takes place over the prepared honeycomb core 12. A suitable resin distributing medium 38 is positioned on the peel ply 36 (for example a meshed mat). A resin feed line 40 for example in the form of a silicon profile (specialized term: “Q-pipe”) is applied onto the resin distributing medium 36. The resin feed line 40 is used for feeding liquid matrix material to the dry fiber layers 241, 242 (a so-called resin infusion method). A second upper microporous membrane 42 corresponding to the membrane 32, is now again positioned over this lay-up made of the prepared honeycomb core 120, including adhesive films 201, 202 and barrier layer sheets 161, 162, the fiber layers 241, 242 as well as the adjuvants. The upper microporous membrane 42 in the boundary area is bonded to the lower microporous membrane 32 completely sealed peripherally by means of a suitable sealant tape 43, so as to form a partial space 44 sealed with respect to liquid matrix material, in which the lay-up consisting of the prepared honeycomb core 120, including adhesive films 201, 202 and barrier layer sheets 161, 162 and the fiber layers 241, 242 is confined. Concerning this, it should be noted that, although a membrane 42 on the upper side might basically be sufficient for obtaining the advantages of the VAP method, the flow behaviour and the distribution of the resin on the underside are substantially improved by the membrane 32 in addition to de-aeration on the underside of the fabric. A non-woven fabric or a distributing medium 46 then follows as a spacer, which subsequently supports uniform de-aeration or degassing. Finally, a vacuum bag 48 in a suitable material (for example silicon) together with a vacuum connection 50 is positioned on the described lay-out. Here steps are taken (for example by means of a fall of the folds), in order to prevent subsequent unintended stresses on the lay-up. The vacuum bag 48 is sealably bound completely peripherally to the moulding tool 30 by means of a suitable vacuum-tight tape 51 (specialized term: “sealant tape”). In this way, the partial space 44 as well as the lay-up structure found therein (241, 120, 242) for the sandwich component 12 to be manufactured, are confined in a gas-tight space 52, in which a vacuum may be produced with the aid of the vacuum connection 50. For this, a vacuum pump not shown is connected to the vacuum connection 50. For the structure, and in particular for the vacuum bag 48 and sealant tape 51 used, it is guaranteed that a vacuum <1 mbar may be maintained on a fairly long-term basis in the space 52 with a suitable vacuum pump. The moulding tool 30 with the structure described above, may for example be placed in an oven, subsequently to the method steps described further below.

FIG. 4 schematically shows an exemplary structure for performing a second alternative method (specialized term: “Resin Film Infusion” RFI). The structure according to FIG. 4 is basically like the one in FIG. 3. Identical or similar elements in FIG. 4 are provided with the same reference marks as in FIG. 3 and are not described again.

Unlike the alternative according to FIG. 3, in the case of the structure according to FIG. 4, the components for feeding the liquid resin as well as the resin distributing media are no longer necessary. This is made possible by the fact that easily flowable resin films 41 of uncured resin are used as a source for the matrix material, which films are initially laid down in the lay-up, directly between various dry tissue or lay-up layers 2411, 2412 or 2421, 2422 for the upper or lower cover layer 14 and/or between the inmost tissue or lay-up layers 2412, 2422 and the prepared honeycomb core 120. Additional corresponding release films 35, 36, may additionally be laid under the lower peel ply 34 and on the upper peel ply 36. Also for the structure according to FIG. 4, a vacuum is subsequently produced in the gas-tight space 52 by means of a vacuum pump (not shown) via the vacuum connection 50.

By using resin films 41 (RFI), as illustrated in FIG. 4, instead of feeding liquid resin (RI), direct resin infusion may occur on the smallest space in the tissue or lay-up layers 2411, 2412, or 2421, 2422. For this, the resin films are liquefied under the effect of heat. The possibility of being able to adjust the resin/fiber ratio in a defined way, in particular with a lower fluctuation range, but also the reduction of the waste of resin (which is produced in the RI method, for example in the distributing medium or in the hose pipes) are counted among the advantages of using resin films.

Concerning FIG. 3 and FIG. 4, there remains to be noted that these are exemplary schematic illustrations. The actual structure of the laid fabric (specialized term: lay-up), for example with regard to the number of woven or non-woven layers used, as well as the type and shape of the honeycomb core used, naturally depend on the components.

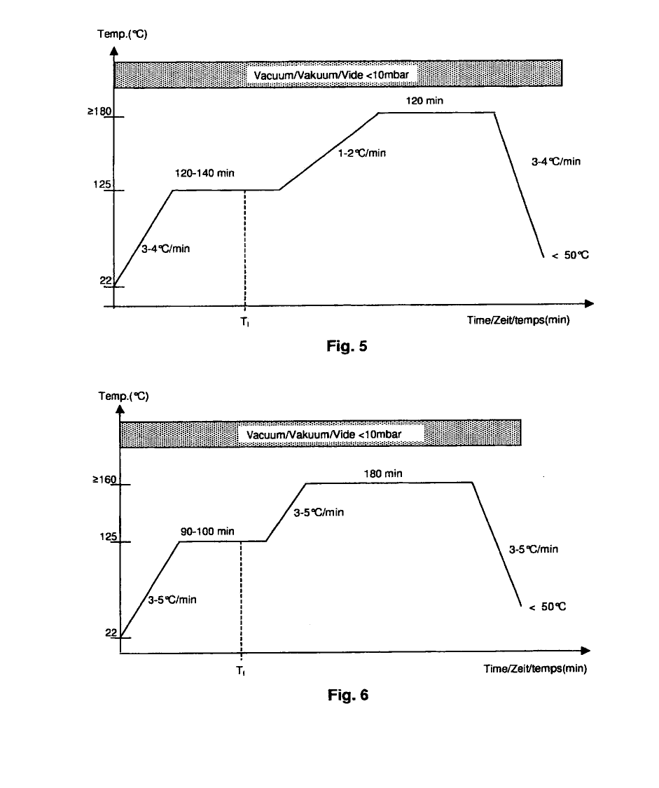

With the help of FIGS. 5-7, a few examples will now be described on the further development of the method for a structure according to FIG. 3.

### Example 1

### FIG. 5

The temperature-time diagram according to FIG. 5 illustrates the steps of the method when using one of the following one-component epoxy resins as matrix material for making the fiber composite cover layers 14: “RTM 6” (available from Hexcel), “Cycom 977-2” (available from Cytec) or “EPS 600” (available from Bakelite). As for these resins, these are structural resins, which are authorized for fiber composite structural components intended for the aeronautical industry.

A structure according to FIG. 3 is first brought into a simple oven with temperature control and connected to a vacuum pump via the vacuum connection 50. As apparent from FIG. 5, the vacuum is produced in the closed space 52, and because of the gas-pervious, microporous membranes 32, 42 also produced in the intermediate space 44, before an increase in temperature takes place. In this way, it is guaranteed that the complete or partial curing of the adhesive layer 20 (adhesive films 201,202) between the honeycomb core 12 and the barrier layer 16 only takes place after the honeycomb cells 18 are exposed to this vacuum, so that the honeycomb cells are at least partly evacuated, before they are closed by the barrier layer 16 (and the cured adhesive films 201,202). After the vacuum has been produced, the temperature in the oven is increased to a first process temperature of about 125° C. with a slope of the temperature curve of about 3-4° C./min. Next, the current adhesive layer 20 (adhesive films 201, 202) between the honeycomb core 12 and the barrier layer 16 is cured at this temperature under the effect of heat, during a time interval of about 120-140 minutes. It should be noted that before the complete curing of the adhesive layers 20, a de-aeration as large as possible of the honeycomb cells 18 has taken place. When the adhesive layers 20 are cured, the feed of liquid matrix material (in this example RTM 6; Cycom 977-2 or EPS 600) is switched on at instant Tᵢ at the same temperature in the oven. Here, the resin is warmed up to a temperature which imparts to the latter sufficient flowability or viscosity, for example to 80° C. After the resin has been distributed by vacuum infusion uniformly into the initially dry fiber layers to be impregnated, the temperature in the oven is increased with a rate of increase of about 1-2° C./min up to a second process temperature of about 180° C. The respective barrier layer 16 here prevents undesired penetration of matrix material into the honeycomb cells 18. Now, the resin is completely cured during a period of about 120 minutes. The structure is then again cooled down to room temperature with a rate of decrease of about 3-4° C./min. As apparent from FIG. 5, vacuum is applied to the lay-up during the whole oven process and in particular to the open cell honeycomb core 12 already before partial or complete curing of the adhesive layers 20, i.e. when the honeycomb core is not yet sealed off or approximately sealed off. Herein, the dwelling time during or before the heating under vacuum of the adhesive layers 20 to complete or partial curing temperature, is selected so as to establish a partial vacuum ≦100 mbars, preferably ≦50 mbars, in the honeycomb cells (averaged over the honeycomb cells), before said complete or partial curing temperature is reached.

### Example 2

### FIG. 6

The temperature-time diagram according to FIG. 6 illustrates the steps of the method when using one of the following epoxy diisocyanurate resins as matrix material for manufacturing fiber composite cover layers 14: Blendur® 4520 or Blendur® 4516 or mixtures thereof (available from BAYER Material Science) or the resin system P15 or P30 (available from LONZA). Concerning the Blendur® resin systems (about 80% diphenylmethane-diisocyanate and 20% epoxy resin based on bisphenol A) and suitable mixtures thereof or therewith, it should be noted that these are suitable for structural components (bearing surface elements) and in particular for fitting out interiors (specialized term “interior components”) in aircraft construction, because of their flame-retarding properties. Furthermore polyisocyanurate resins are suitable because of their general treatment properties but in particular their viscosity characteristic, particularly good for the infusion technology of the method according to the invention.

Also in this example, a structure according to FIG. 3 is first brought into a simple oven with temperature control. The vacuum is produced in the closed space 52 and also in the intermediate space 44 via the vacuum connection 50 and a vacuum pump, and indeed already before an increase in temperature occurs. After an increase in temperature with a slope of about 3-5° C./min and after de-aeration of the honeycomb cells 18 has already taken place, the adhesive layers 20 (adhesive films 201, 202) are cured at a first process temperature of about 125° C. Next, warmed liquid resin is infused into the fiber layers 241, 242 under the effect of a vacuum. After an increase in temperature with a slope from about 3-5° C./min, the resin is cured at a second process temperature of about 160° C. for about 180 minutes. Next, the structure is cooled to room temperature with a cooling rate of about 3-5° C./min. Thus, in this example, a vacuum is also applied to the fabric and therefore also to honeycomb core 12 which is not yet sealed already before partial or complete curing of the adhesive layers 20. Also here, a pressure of ≦100 mbars, preferably ≦50 mbars in the honeycomb cells is preferably applied to the honeycomb cells before the complete or partial curing temperature of the adhesive layers 20 is reached.

### Example 3

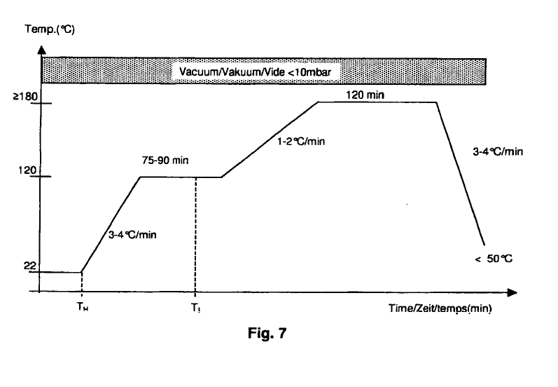

### FIG. 7

In Example 3, the same resin systems may be used as in Example 1. The steps of the method of Example 3 mostly correspond to those according to FIG. 3, wherein however the dually curable resin used for the adhesive layers is only partially cured and not completely cured for a slightly lower first process temperature of about 120° C. during a shorter time interval of about 75-90 minutes. It turned out that a sufficient seal of the honeycomb cell 18 with regard to the liquid matrix material is already guaranteed, before the adhesive layers 20 are completely cured. Thus energy and oven occupancy time may be saved, since the dually curable resin (adhesive films 201, 202) may completely cure during the subsequent curing of the resin of the cover layers 14, which is required in any case. Furthermore, the example of FIG. 3 differs to the effect that a vacuum is applied to the fabric already during a dwelling time TH, before initiating the temperature increase for curing the adhesive layers 20. A corresponding interval T_{H} is selected in function on the volume of the honeycomb core to be de-aerated (e.g. about 10 min) and may for example guarantee maximum evacuation of air or gas from the honeycomb cells for bigger components or for honeycomb cores with larger cell volumes. Also in this embodiment, a pressure of ≦100 mbars, preferably ≦50 mbars is produced in the honeycomb cells before the complete or partial curing temperature of the adhesive layers 20 is reached.

As a material for the adhesive films 161, 162, in all the examples, a resin is used, for example an epoxy resin or a phenolic resin or a suitable mixture thereof, which is curable at both of the different process temperatures (“dually curable”), so that the adhesive layer 20 does not incur any damages by excess temperature equilibration at a higher curing temperature for the embedding matrix material 26. Additionally, demand is made on the resin used that it should be compatible with the barrier layer sheets 161, 162 and naturally the honeycomb core 12.

The dwelling time T_{I} at the first process temperature for complete or partial curing of the adhesive layer 20 is always selected so that before the infusion of the fiber layers 241, 242 with the liquid matrix material, the honeycomb cells 18 are sealed relatively to the matrix material, so that no matrix material may unintentionally penetrate into the honeycomb cells 18.

Concerning the barrier layer 16 (sheets 161, 162), which is obligatorily impervious for the matrix material, it is basically advantageous for the de-aeration described above of the honeycomb cells 18, if the barrier layer 16 per se has a certain minimum perviousness to gas, so it is conceivable to also use a suitable microporous membrane for the barrier layer 16. On the other hand, this requirement is against the goal of sealing as hermetically as possible the honeycomb core 12 of the finished sandwich component 10, in order to prevent undesirable accumulation of moisture in the honeycomb cells 18 on a fairly long-term basis. In order to achieve the latter goal, the barrier layer 16 should have gas perviousness as small as possible. Together with the surface-treated sheets 161, 162 described above in a thermoplastic, a plurality of other materials are conceivable for the barrier layer 16. If a technical gas-impervious barrier layer 16 is used, steps should be provided in order to guarantee sufficient de-aeration of the honeycomb core 12, at least before partial or complete curing of the adhesive layers 20, (as described further below). This applies in particular when honeycomb cells 18 at the periphery of the honeycomb core 12 are filled with a core filling mass (specialized term: “potting”), so that gas may also only escape with difficulty laterally out of the honeycomb core 12. Special agents may be provided for example for de-aerating the honeycomb core 12. De-aeration holes may be made or de-aeration apertures may be provided laterally in the boundary area of the honeycomb core 12 alone, or else, in the potting boundary. Additionally or alternatively, the entire material for the honeycomb core may be perforated or have suitable high gas-perviousness. Alternatively or additionally to this, de-aeration holes may be provided, either offset or direct, transverse to the sandwich layers, at certain positions in the barrier layer 16, only in one or in both barrier layers 16. Only the honeycomb cells 18 corresponding to the de-aeration holes are filled during the infusion with resin, and may subsequently be used for example as attachment points in the finished component 10. Such de-aeration agents may in particular shorten the process duration for large components, since the honeycomb core 12 may be de-aerated more rapidly. With the proposed de-aeration means, it is possible to achieve satisfactory evacuation (e.g. ≦100 mbars) of the honeycomb cells within a short time, without having to provide a special additional layer, not needed in the subsequently completed component, between the barrier layer 13 and the honeycomb core 12 for de-aeration and in particular without an excessively long dwelling time T_{H}. Depending on the barrier layer and adhesive layer combination used and on the de-aeration means optionally used, the applied vacuum pressure of ≦10 mbars, preferably ≦1 mbar, can be approximately produced also on average in the honeycomb cells, using if necessary a correspondingly increased dwelling time TH.

In the method according to the invention, a multiple function falls on the permanently applied vacuum. By producing the vacuum before complete or partial curing of the adhesive layers 20, the honeycomb cells 18 are initially at least partly evacuated. In this way, a more homogenous bond of the respective cover sheet 16 to the honeycomb core is made possible on the one hand, this adhesive bond being thereby improved, and a subsequent diffusion of gases out of the honeycomb cells into the curing matrix material of the current cover sheet 14 is prevented to the greatest possible extent in the further course of the process, whereby a reduction in the porosity of this fiber composite is guaranteed. By maintaining the vacuum during the complete or partial curing of the adhesive layers 20, the barrier layer 16 is uniformly pressed against the honeycomb core 12 and gases which are formed from the partially or completely curing adhesive material, are discharged to the greatest possible extent, both out of the adhesive layers 20 and out of the honeycomb cells 18. By degassing the adhesive layers 20 during the curing, the quality of the adhesive bond is further improved. By the vacuum further applied during the subsequent vacuum-assisted matrix material infusion and the subsequent curing of the matrix material, the formation of air or gas inclusions and a resulting formation of pores in the fiber composite are generally reduced in the way known for RI and RFI methods. The initial evacuation mentioned above of the honeycomb cells 18 acts here as an assistance. During the use of the microporous membrane 32, 42 according to the VAP method, a two-dimensional uniform and fast initial de-aeration as far as possible of the honeycomb cells 18 as well of the adhesive layer 20 and also a two-dimensional, uniform de-aeration of the matrix material in the transverse direction to the component surface are made possible. Although the VAP-method because of its improved results is to be considered as preferred, the method according to the invention may basically be performed also without the microporous membranes 32, 42, according to conventional vacuum infusion methods (RI, RFI without VAP).

As apparent from the examples above, numerous matrix materials 26 may basically be used for the cover layers 14, for example an epoxy resin, a cyanurate resin, a polyester resin, a phenolic resin, a vinyl ester resin, an acryl resin, a silane or a mixture of at least two of these resins, since these resins cure comparatively rapidly and are well processible. When using a microporous membrane (32, 42) according to the VAP method, compatibility between this membrane (32, 42) and the matrix material 26 should however be taken into account. Also the dry fiber material 24 may basically be used in the most diverse initial forms for example in the form of a tissue, a fabric, a braiding, a netted fabric, a knit fabric, a non-woven fabric or hybrid material. The used form of the fiber material should be able to be uniformly impregnated with liquid matrix material and should have excellent mechanical strength with at the same time exceptional elastic properties after complete curing of the matrix material, depending on the system combination used. As fiber material, materials which have glass fibers, carbon fibers, boron fibers, aramide fibers, ceramic fibers, metal fibers and/or metal wires are preferably used for this purpose. Alternatively or combined thereto, materials which are based on thermoplastic plastics or elastomers, may also be applied as fiber material. The honeycomb core 12 per se may also be manufactured with a different specific weight and out of different material depending on the application of the sandwich component 10. Paper, cardboard, a fiber material or a combination thereof, may be used as a material for the honeycomb. Such honeycomb structures have a particularly high strength-to-weight ratio. Honeycomb structures of paper or cardboard are preferred, in which the paper or cardboard material is completed with aramide fibers, in particular Nomex® or Kevlar® fibers, polyester fibers, PVC fibers, polyacryl fibers, polypropylene fibers or a mixture of at least two or these fiber types. The honeycomb structures may additionally be impregnated with resin. The honeycomb structure may of course be manufactured out of thin metal sheets, preferably in aluminum, or else in a plastic material.

1.-17. (canceled)

18. A method for manufacturing a sandwich component with a honeycomb core having webs which are sealed on both sides, said webs being sealed at least on one side by means of a cover layer made of a fiber material embedded in a matrix material, said method comprising:
manufacturing a lay-up comprising a honeycomb core having honeycomb cells and, at least on one side on said honeycomb core and from the inside to the outside, a curable adhesive layer on the outside of said honeycomb core, a barrier layer and a fiber layer;
confining said lay-up on a one-sided moulding tool in a gas-tight space formed by means of a vacuum sheet on said one-sided moulding tool;
producing a vacuum in said gas-tight space;
after producing said vacuum, complete or partial curing of said adhesive layer between said honeycomb core and said barrier layer under said vacuum, so that said honeycomb cells are at least partly evacuated before they are sealed by said barrier layer;
after complete or partial curing of said adhesive layer, infusing said fiber layer under vacuum with a matrix material; and
curing said matrix material under vacuum.

19. The method according to claim 18, further comprising:
before enclosing said lay-up in said gas-tight space, confining said lay-up in a partial space sealed with regard to matrix material by means of a microporous membrane which is impervious for matrix material and pervious for gases.

20. The method according to claim 18, wherein infusing said fiber layer comprises impregnation of fiber material by means of liquid matrix material fed to said lay-up from the outside.

21. The method according to claim 18, wherein said lay-up further comprises one or more matrix material films and wherein infusing said fiber layer comprises impregnation of fiber material by means of matrix material liquefied out of said one or more matrix material films.

22. The method according to claim 18, wherein said barrier layer is a sheet which is surface-treated, preferably by a plasma or corona surface treatment, by means of a coating method or by a combination thereof.

23. The method according to claim 18, wherein, before complete or partial curing of said adhesive layer, said produced vacuum is applied to said lay-up during a dwelling time and wherein said adhesive layer is completely or partially cured under the effect of heat applied according to a temperature curve, said dwelling time and/or said temperature curve being selected so that an evacuation of said honeycomb cells that corresponds approximately to said produced vacuum is achieved before said adhesive layer is partially or completely cured.

24. The method according to claim 18, wherein a vacuum of ≦10 mbar, preferably ≦1 mbar is produced.

25. The method according to claim 18, wherein said curable adhesive layer is directly positioned on said honeycomb core and said barrier layer is positioned directly on said adhesive layer.

26. The method according to claim 18, wherein said adhesive layer has a process temperature for complete or partial curing of said adhesive layer and said matrix material has an infusion temperature, said adhesive layer and said matrix material being selected so that said infusion temperature essentially corresponds to said process temperature.

27. The method according to claim 18, wherein complete or partial curing of said adhesive layer is performed by the effect of heat at a first process temperature, and curing said matrix material is performed by the effect of heat at a second process temperature, said first process temperature being lower than said second process temperature and wherein said adhesive layer is curable in the range of said first and of said second process temperature.

28. The method according to claim 27, wherein said adhesive layer is an adhesive film based on an epoxy resin or on a phenolic resin or on a mixture thereof.

29. The method according to claim 18, wherein complete or partial curing of said adhesive layer is performed by the effect of heat at a first process temperature, and curing said matrix material is performed by the effect of heat at a second process temperature, said first process temperature being lower than said second process temperature and wherein said adhesive layer is partially curable in the range of said first process temperature and completely curable in the range of said second process temperature.

30. The method according to claim 29, wherein said adhesive layer is an adhesive film based on an epoxy resin or on a phenolic resin or on a mixture thereof.

31. A sandwich component manufactured according to the method of claim 1, said sandwich component having layers and comprising:
a honeycomb core having webs which are sealed on both sides,
at least one cover layer which seals said honeycomb core on one side and is made of
a fiber material embedded in a matrix material, and
a barrier layer between said honeycomb core and said cover layer,
wherein said cover layer has a pore volume content ≦2%; and
wherein, in a tensile test with said sandwich component, a tensile strength perpendicular to said sandwich layers of ≧3 MPa is obtained, respectively, a honeycomb failure is obtained for an intrinsic tensile strength of said honeycomb core of <3 MPa.

32. The sandwich component according to claim 31, said sandwich component having a tensile strength of at least 1.5 MPa perpendicularly to said sandwich layers.

33. The sandwich component according to claim 31, wherein, in a tensile test with said sandwich component, a tensile strength perpendicular to said sandwich layers of ≧4 MPa is obtained, respectively, a honeycomb failure is obtained for an intrinsic tensile strength of said honeycomb core of <4 MPa.

34. The sandwich component according to claim 31 when produced according to the method of claim 2, wherein said cover layer has a pore volume content <0.5%.

35. A sandwich component produced according to the method of claim 19, said sandwich component having layers and comprising:
a honeycomb core that has an intrinsic tensile strength of ≧4 MPa and is sealed on both sides,
at least one cover layer which seals said honeycomb core on one side and is made of
a fiber material embedded in a matrix material, and
a barrier layer between said honeycomb core and said cover layer;
wherein said cover layer has a pore volume content ≦0.5% and said sandwich component has a tensile strength perpendicular to said sandwich layers of ≧4 MPa.
